(19) United States
(12) Patent Application Publication
(10) Pub. No.: US 2025/0180455 A1
(43) Pub. Date: Jun. 5, 2025

(54) TESTING DEVICE AND METHOD FOR IMMERSING MATERIALS IN HIGH-TEMPERATURE AND HIGH-PRESSURE HYDROGEN GAS

(71) Applicant: METAL INDUSTRIES RESEARCH & DEVELOPMENT CENTRE, Kaohsiung (TW)

(72) Inventors: Hui-Ju CHEN, Kaohsiung (TW); Zong-Rong LIU, Kaohsiung (TW); Hsiu-An TSAI, Kaohsiung (TW)

(21) Appl. No.: 18/528,809

(22) Filed: Dec. 5, 2023

(51) Int. Cl. G01N 15/00; G01N 17/00

(52) U.S. Cl. CPC G01N 15/00; G01N 17/002; G01N 2015/0015

(57) ABSTRACT

A testing device and method for infiltrating a material into high-temperature and high-pressure hydrogen are provided. The testing device includes a high-pressure cabin, internally including a sample to be tested; a hot oil-coated heating and insulation system, coating outside the high-pressure cabin to adjust and maintain a temperature in the high-pressure cabin; a hydrogen compressor, communicated with the high-pressure cabin to adjust a pressure in the high-pressure cabin; a vacuum pump, communicated with the high-pressure cabin to vacuumize the high-pressure cabin; a scavenging system, communicated with the high-pressure cabin to purge air impurities in the high-pressure cabin with an inert gas; and a controller, electrically connected with the hydrogen compressor, the vacuum pump, and the scavenging system, and configured to control actions of the hydrogen compressor, the vacuum pump, and the scavenging system.

### BACKGROUND

### Technical Field

The present invention relates to a testing device, in particular to a testing device and method for infiltrating a material into high-temperature and high-pressure hydrogen.

### Related Art

In recent years, as the climate anomaly gradually intensifies, calls for zero carbon emission are increasing. Hydrogen is regarded as one of the representatives of the next generation of clean energy. Hydrogen fuel cells, hydrogen energy automobiles and the like are currently trying to use hydrogen instead of original fossil fuels to serve as the combustion reaction energy source. However, delayed crack, mechanical property weakening, material embrittlement, and other problems generated by materials, especially metal materials, in the hydrogen environment also emerge. How does hydrogen embrittlement form, and how to detect it before the product fails, or how to effectively select suitable materials for hydrogen system components are important issues.

Hydrogen is in the gaseous state when being combusted for use, so it cannot be stored in the liquid state. In addition, to store fuel efficiently, as much hydrogen as possible should be compressed into the storage system. In the operating process, the thermal energy in the environment and provided by the reaction makes the overall system temperature raise, so that the material changes under the high-temperature and high-pressure hydrogen environment must be observed.

However, the current tests of samples for hydrogen embrittlement do not have the devices or methods to effectively reduce interference factors in the testing environment and ensure that the test is done in an effective gas environment.

### SUMMARY

Based on the above reasons, one purpose of the present invention is to provide a testing device and method for infiltrating a material into high-temperature and high-pressure hydrogen, so as to effectively reduce interference factors in the testing environment and ensure that the test is done in an effective gas environment; and more advantageously, hot oil is used for coating a heating and insulation system, so as to maintain a stable constant temperature in a high-pressure cabin for a long time, and avoid significant temperature changes or surges cause the test results to be disturbed by uncontrollable factors.

To achieve the above purpose, the present invention is directed to a testing device for infiltrating a material into high-temperature and high-pressure hydrogen, comprising: a high-pressure cabin, internally including a sample to be tested; a hot oil-coated heating and insulation system, coating outside the high-pressure cabin to perform heating and heat insulation on the high-pressure cabin to adjust and maintain a temperature in the high-pressure cabin; a hydrogen compressor, communicated with the high-pressure cabin to adjust a pressure in the high-pressure cabin; a vacuum pump, communicated with the high-pressure cabin to vacuumize the high-pressure cabin; a scavenging system, communicated with the high-pressure cabin to purge air impurities in the high-pressure cabin with an inert gas; and a controller, electrically connected with the hydrogen compressor, the vacuum pump and the scavenging system to control actions of the hydrogen compressor, the vacuum pump and the scavenging system.

In some embodiments, the high-pressure cabin is made of a stainless steel material.

In some embodiments, the hydrogen compressor is further connected with an air compressor and a hydrogen source. The hydrogen compressor provides a gas-supply pressure for the hydrogen compressor, and the hydrogen source provides a hydrogen source for the hydrogen compressor.

In some embodiments, the controller is electrically connected with the hydrogen compressor, the vacuum pump and the scavenging system through an electromagnetic valve, and is configured to control the actions of the hydrogen compressor, the vacuum pump and the scavenging system through the electromagnetic valve.

In some embodiments, the testing device further comprises a sampling valve, connected with an interior of the high-pressure cabin to sample within the high-pressure cabin.

In some embodiments, the testing device further comprises a thermocouple, connected with the interior of the high-pressure cabin to measure the temperature in the high-pressure cabin.

In some embodiments, the testing device further comprises a rupture disc, connected with the high-pressure cabin to perform explosion venting when the pressure inside the high-pressure cabin is too high.

In some embodiments, the testing device further comprises a monitoring system, electrically connected with the thermocouple and the sampling valve, and configured to monitor the temperature in the high-pressure cabin and conditions of the sample to be tested.

In some embodiments, the testing device further comprises a thermometer, connected with the high-pressure cabin and the controller, and configured to control the temperature adjustment and maintenance of the hot oil-coated heating and insulation system according to the temperature in the high-pressure cabin through feedback of the controller.

The present invention is further directed to a testing method for infiltrating a material into high-temperature and high-pressure hydrogen, comprising: determining a target environment hydrogen atom saturation concentration; determining a test duration; selecting a temperature and a pressure; placing a sample to be tested in a high-pressure cabin and airtightly locking the high-pressure cabin; performing vacuumizing; performing purging with an inert gas to remove air impurities in the high-pressure cabin; introducing a specified gas into the high-pressure cabin to a specified pressure; raising the temperature of the high-pressure cabin to a specified temperature to infiltrate the sample to be tested; and after infiltrating the sample to be tested for the test duration, taking out the sample to be tested for mechanical test and numerical analysis.

In some embodiments, the testing method is a constant-temperature and constant-pressure test, and the specified gas comprises pure hydrogen or is a hydrogen mixed gas.

In some embodiments, the step of introducing a specified gas into the high-pressure cabin to a specified pressure is performed after a plurality of times of vacuumizing and inert gas purging.

In some embodiments, the inert gas is nitrogen.

In some embodiments, the step of performing purging with an inert gas to remove air impurities in the high-pressure cabin further comprises maintaining the pressure to test leakage.

In some embodiments, the mechanical test comprises tensile, yielding strength, and reduction of area.

The present invention is further directed to a testing method for infiltrating a material into high-temperature and high-pressure hydrogen, comprising: determining a target environment temperature, an environment pressure, and a preset number of hydrogen charging; preparing a geometrical shape of a sample to be tested; placing a sample to be tested in a high-pressure cabin and airtightly locking the high-pressure cabin; performing vacuumizing; performing purging with an inert gas to remove air impurities in the high-pressure cabin; introducing a specified gas into the high-pressure cabin to a specified pressure and a specified temperature; after maintaining for a specified period of time, opening a release valve to reduce the specified pressure to a normal pressure; determining whether the number of hydrogen charging is reached, if not, returning to the step of introducing a specified gas into the high-pressure cabin to a specified pressure and a specified temperature, and if yes, proceeding to a next step; injecting an inert gas into the high-pressure cabin to reduce the specified temperature to 40° C. or below and reduce the specified pressure to the normal pressure; and taking out the sample to be tested for mechanical test and numerical analysis.

In some embodiments, the testing method is a cyclic pressure test, and the specified gas comprises pure hydrogen or is a hydrogen mixed gas.

In some embodiments, the step of performing purging with an inert gas to remove air impurities in the high-pressure cabin further comprises maintaining the pressure to test leakage.

In some embodiments, the mechanical test comprises tensile, yielding strength, and reduction of area.

In some embodiments, the mechanical test comprises tensile, yielding strength, and reduction of area.

The technical characteristics and advantages of the present disclosure have been quite broadly set forth above, so that the detailed description of the present disclosure below can be better understood. Other technical characteristics and advantages constituting the subject matter of the claims of the present disclosure will be described below. Those of ordinary skill in the art should understand that it is very easy to utilize the concept and specific embodiments disclosed below as modifications or to design other structures or processes to realize the same purpose as the present disclosure. Those of ordinary skill in the art should also understand that such equivalent constructs do not depart from the spirit and scope of the present disclosure defined by the following claims.

### BRIEF DESCRIPTION OF THE DRAWINGS

FIG. 1 is a schematic structural diagram of a testing device for infiltrating a material into high-temperature and high-pressure hydrogen according to the present invention.

FIG. 2 is a schematic flow chart of a testing method for infiltrating a material into high-temperature and high-pressure hydrogen according to the present invention.

FIG. 3 is a schematic flow chart of a testing method for infiltrating a material into high-temperature and high-pressure hydrogen to perform a plurality of times of cycles.

### DETAILED DESCRIPTION

The specific implementations of the present invention is described in detail below in combination with specific conditions.

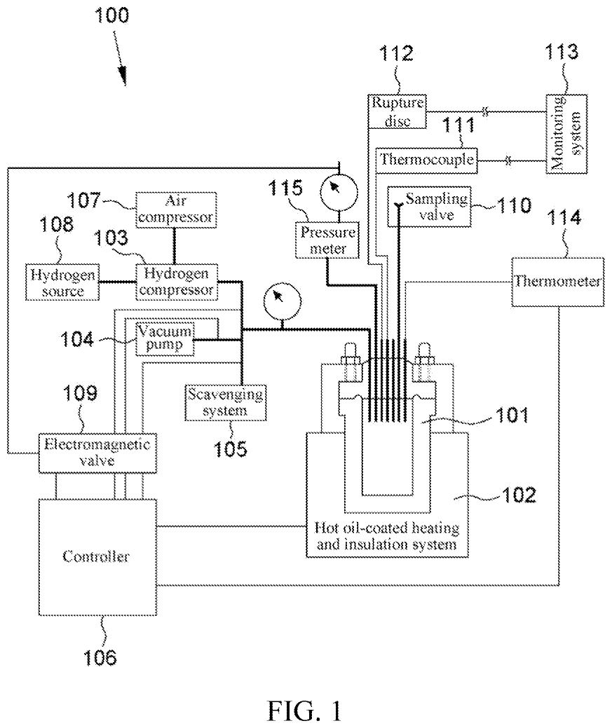

FIG. 1 is a schematic structural diagram of a testing device for infiltrating a material into high-temperature and high-pressure hydrogen according to the present invention.

Referring to FIG. 1, a testing device 100 for infiltrating a material into high-temperature and high-pressure hydrogen according to the present invention may include a high-pressure cabin 101, a hot oil-coated heating and insulation system 102, a hydrogen compressor 103, a vacuum pump 104, a scavenging system 105, and a controller 106.

Referring to FIG. 1, the high-pressure cabin 101 is a hollow cabin, and internally includes a sample to be tested (not shown). In some embodiments, the high-pressure cabin 101 may be made of a stainless steel material. In some embodiments, the high-pressure cabin 101 is made of SS316L stainless steel, but is not limited thereto.

The hot oil-coated heating and insulation system 102 has hot oil flow therein, so as to uniformly conduct heat and realize the effects of uniform heating and temperature maintaining. The hot oil-coated heating and insulation system 102 coats outside the high-pressure cabin 101, so as to perform heating and heat insulation on the high-pressure cabin 101 to adjust and maintain a temperature in the high-pressure cabin 101. Therefore, the hot oil-coated heating and insulation system 102 may maintain a stable constant temperature in the high-pressure cabin 101 for a long time, and avoid significant temperature changes or surges cause the test results to be disturbed by uncontrollable factors.

The hydrogen compressor 103 is communicated with the high-pressure cabin 101, and is configured to adjust a pressure in the high-pressure cabin 101. In some embodiments, the hydrogen compressor 103 is further connected with an air compressor 107 and a hydrogen source 108. The hydrogen compressor 107 provides a gas-supply pressure for the hydrogen compressor 103, and the hydrogen source 108 provides a hydrogen source for the hydrogen compressor 103.

The vacuum pump 104 is communicated with the high-pressure cabin 101, and is configured to vacuumize the high-pressure cabin 101.

The scavenging system 105 is communicated with the high-pressure cabin 101, and is configured to purge air impurities in the high-pressure cabin 101 with an inert gas.

The controller 106 is electrically connected with the hydrogen compressor 103, the vacuum pump 104, and the scavenging system 105, and is configured to control actions of the hydrogen compressor 103, the vacuum pump 104, and the scavenging system 105. In some embodiments, the controller 106 is electrically connected with the hydrogen compressor 103, the vacuum pump 104, and the scavenging system 105 through an electromagnetic valve 109, and is configured to control the actions of the hydrogen compressor 103, the vacuum pump 104, and the scavenging system 105 through the electromagnetic valve 109. In some embodiments, the controller 106 is a PLC controller.

In some embodiments, a pressure meter 115 is connected between the high-pressure cabin 101 and the electromagnetic valve 109 to measure a pressure value in the high-pressure cabin 101.

The testing device 100 according to the present invention may further include a sampling valve 110, a thermocouple 111, a rupture disc 112, a monitoring system 113, and a thermometer 114. The sampling valve 110 may be connected with an interior of the high-pressure cabin 101 to sample within the high-pressure cabin 101. The thermocouple 111 may be connected with the interior of the high-pressure cabin 101 to measure the temperature in the high-pressure cabin 101. The rupture disc 112 may be connected with the high-pressure cabin 101 to perform explosion venting when the pressure inside the high-pressure cabin 101 is too high. The monitoring system 113 may be electrically connected with the thermocouple 111 and the sampling valve 110, and is configured to monitor the temperature in the high-pressure cabin 101 and conditions of the sample to be tested. The thermometer 114 may be connected with the high-pressure cabin 101 and the controller 106, and is configured to control the temperature adjustment and maintenance of the hot oil-coated heating and insulation system 102 according to the temperature in the high-pressure cabin 101 through feedback of the controller 106.

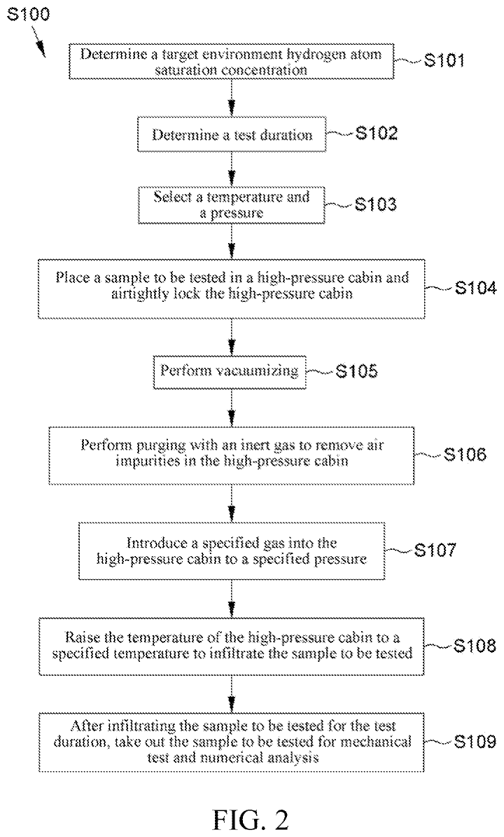

FIG. 2 is a schematic flow chart of a testing method for infiltrating a material into high-temperature and high-pressure hydrogen according to the present invention. Referring to FIG. 2, a testing method S100 according to the present invention is a constant-temperature and constant-pressure test, and may include: determine a target environment hydrogen atom saturation concentration (step S101); determine a test duration (step S102); select a temperature and a pressure (step S103); place a sample to be tested in a high-pressure cabin and airtightly lock the high-pressure cabin (step S104); perform vacuumizing (step S105); perform purging with an inert gas to remove air impurities in the high-pressure cabin (step S106); introduce a specified gas into the high-pressure cabin to a specified pressure (step S107); raise the temperature of the high-pressure cabin to a specified temperature to infiltrate the sample to be tested (step S108); and after infiltrating the sample to be tested for the test duration, take out the sample to be tested for mechanical test and numerical analysis (step S109).

In step S106, the specified gas includes pure hydrogen or is a hydrogen mixed gas. In some embodiments, step S106 further includes maintain the pressure to test leakage.

In step S107, the inert gas is nitrogen. In some embodiments, step S107 is performed after a plurality of times of vacuumizing and inert gas purging.

By step S107 and step S108, interference factors in a testing environment may be effectively reduced.

In step S109, the mechanical test includes tensile, yielding strength, and reduction of area.

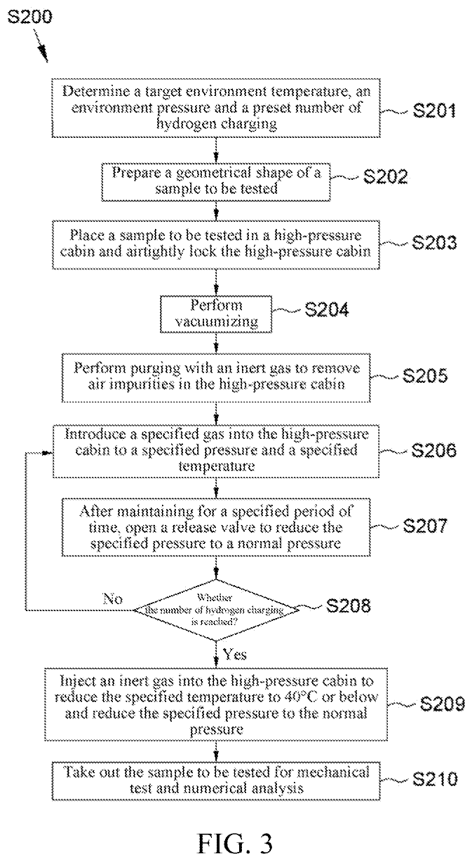

FIG. 3 is a schematic flow chart of a testing method for infiltrating a material into high-temperature and high-pressure hydrogen to perform a plurality of times of cycles. A testing method S200 of FIG. 3 is a cyclic pressure test, and may include: determine a target environment temperature, an environment pressure, and a preset number of hydrogen charging (step S201); prepare a geometrical shape of a sample to be tested (step S202); place a sample to be tested in a high-pressure cabin and airtightly lock the high-pressure cabin (step S203); perform vacuumizing (step S204); perform purging with an inert gas to remove air impurities in the high-pressure cabin (step S205); introduce a specified gas into the high-pressure cabin to a specified pressure and a specified temperature (step S206); after maintaining for a specified period of time, open a release valve to reduce the specified pressure to a normal pressure (step S207); determine whether the number of hydrogen charging is reached (step S208), if not, return to the step of introducing a specified gas into the high-pressure cabin to a specified pressure and a specified temperature, and if yes, proceed to a next step; inject an inert gas into the high-pressure cabin to reduce the specified temperature to 40° C. or below and reduce the specified pressure to the normal pressure (step S209); and take out the sample to be tested for mechanical test and numerical analysis (step S210).

In step S206, the specified gas includes pure hydrogen or is a hydrogen mixed gas. In some embodiments, step S206 further includes maintain the pressure to test leakage.

In step S209, the inert gas is nitrogen.

In step S210, the mechanical test includes tensile, yielding strength, and reduction of area.

By means of the testing device 100 and the testing methods S100 and S200 above, the interference factors in the testing environment may be effectively reduced, and the test is ensured to be done in an effective gas environment; and furthermore, the hot oil-coated heating and insulation system 102 is utilized to maintain the stable constant temperature in the high-pressure cabin 101 for a long time, and avoid significant temperature changes or surges cause the test results to be disturbed by uncontrollable factors.

What is claimed is:

1. A testing device for infiltrating a material into high-temperature and high-pressure hydrogen, comprising:
a high-pressure cabin, internally including a sample to be tested;
a hot oil-coated heating and insulation system, coating outside the high-pressure cabin to perform heating and heat insulation on the high-pressure cabin to adjust and maintain a temperature in the high-pressure cabin;
a hydrogen compressor, communicated with the high-pressure cabin to adjust a pressure in the high-pressure cabin;
a vacuum pump, communicated with the high-pressure cabin to vacuumize the high-pressure cabin;
a scavenging system, communicated with the high-pressure cabin to purge air impurities in the high-pressure cabin with an inert gas; and
a controller, electrically connected with the hydrogen compressor, the vacuum pump and the scavenging system to control actions of the hydrogen compressor, the vacuum pump and the scavenging system.

2. The testing device for infiltrating a material into high-temperature and high-pressure hydrogen according to claim 1, wherein the high-pressure cabin is made of a stainless steel material.

3. The testing device for infiltrating a material into high-temperature and high-pressure hydrogen according to claim 1, wherein the hydrogen compressor is further connected with an air compressor and a hydrogen source, the hydrogen compressor provides a gas-supply pressure for the hydrogen compressor, and the hydrogen source provides a hydrogen source for the hydrogen compressor.

4. The testing device for infiltrating a material into high-temperature and high-pressure hydrogen according to claim 1, wherein the controller is electrically connected with the hydrogen compressor, the vacuum pump and the scavenging system through an electromagnetic valve, and is configured to control the actions of the hydrogen compressor, the vacuum pump and the scavenging system through the electromagnetic valve.

5. The testing device for infiltrating a material into high-temperature and high-pressure hydrogen according to claim 1, further comprising a sampling valve, connected with an interior of the high-pressure cabin to sample within the high-pressure cabin.

6. The testing device for infiltrating a material into high-temperature and high-pressure hydrogen according to claim 5, further comprising a thermocouple, connected with the interior of the high-pressure cabin to measure the temperature in the high-pressure cabin.

7. The testing device for infiltrating a material into high-temperature and high-pressure hydrogen according to claim 6, further comprising a rupture disc, connected with the high-pressure cabin to perform explosion venting when the pressure inside the high-pressure cabin is too high.

8. The testing device for infiltrating a material into high-temperature and high-pressure hydrogen according to claim 7, further comprising a monitoring system, electrically connected with the thermocouple and the sampling valve, and configured to monitor the temperature in the high-pressure cabin and conditions of the sample to be tested.

9. The testing device for infiltrating a material into high-temperature and high-pressure hydrogen according to claim 1, further comprising a thermometer, connected with the high-pressure cabin and the controller, and configured to control the temperature adjustment and maintenance of the hot oil-coated heating and insulation system according to the temperature in the high-pressure cabin through feedback of the controller.

10. A testing method for infiltrating a material into high-temperature and high-pressure hydrogen, comprising:
determining a target environment hydrogen atom saturation concentration;
determining a test duration;
selecting a temperature and a pressure;
placing a sample to be tested in a high-pressure cabin and airtightly locking the high-pressure cabin;
performing vacuumizing;
performing purging with an inert gas to remove air impurities in the high-pressure cabin;
introducing a specified gas into the high-pressure cabin to a specified pressure;
raising the temperature of the high-pressure cabin to a specified temperature to infiltrate the sample to be tested; and
after infiltrating the sample to be tested for the test duration, taking out the sample to be tested for mechanical test and numerical analysis.

11. The testing method for infiltrating a material into high-temperature and high-pressure hydrogen according to claim 10, wherein the testing method is a constant-temperature and constant-pressure test, and the specified gas comprises pure hydrogen or is a hydrogen mixed gas.

12. The testing method for infiltrating a material into high-temperature and high-pressure hydrogen according to claim 10, wherein the step of introducing a specified gas into the high-pressure cabin to a specified pressure is performed after a plurality of times of vacuumizing and inert gas purging.

13. The testing method for infiltrating a material into high-temperature and high-pressure hydrogen according to claim 10, wherein the inert gas is nitrogen.

14. The testing method for infiltrating a material into high-temperature and high-pressure hydrogen according to claim 10, wherein the step of performing purging with an inert gas to remove air impurities in the high-pressure cabin further comprises maintaining the pressure to test leakage.

15. The testing method for infiltrating a material into high-temperature and high-pressure hydrogen according to claim 10, wherein the mechanical test comprises tensile, yielding strength, and reduction of area.

16. A testing method for infiltrating a material into high-temperature and high-pressure hydrogen, comprising:
determining a target environment temperature, an environment pressure, and a preset number of hydrogen charging;
preparing a geometrical shape of a sample to be tested;
placing a sample to be tested in a high-pressure cabin and airtightly locking the high-pressure cabin;
performing vacuumizing;
performing purging with an inert gas to remove air impurities in the high-pressure cabin;
introducing a specified gas into the high-pressure cabin to a specified pressure and a specified temperature;
after maintaining for a specified period of time, opening a release valve to reduce the specified pressure to a normal pressure;
determining whether the number of hydrogen charging is reached, if not, returning to the step of introducing a specified gas into the high-pressure cabin to a specified pressure and a specified temperature, and if yes, proceeding to a next step;
injecting an inert gas into the high-pressure cabin to reduce the specified temperature to 40° C. or below and reduce the specified pressure to the normal pressure; and
taking out the sample to be tested for mechanical test and numerical analysis.

17. The testing method for infiltrating a material into high-temperature and high-pressure hydrogen according to claim 16, wherein the testing method is a cyclic pressure test, and the specified gas comprises pure hydrogen or is a hydrogen mixed gas.

18. The testing method for infiltrating a material into high-temperature and high-pressure hydrogen according to claim 16, wherein the step of performing purging with an inert gas to remove air impurities in the high-pressure cabin further comprises maintaining the pressure to test leakage.

19. The testing method for infiltrating a material into high-temperature and high-pressure hydrogen according to claim 16, wherein the mechanical test comprises tensile, yielding strength, and reduction of area.

20. The testing method for infiltrating a material into high-temperature and high-pressure hydrogen according to claim 16, wherein the inert gas is nitrogen.
